(19) United States
(12) Patent Application Publication
(10) Pub. No.: US 2008/0146279 A1
(43) Pub. Date: Jun. 19, 2008

(54) Radio communication apparatus, communication rate setting method, and communication rate setting program recording medium

(75) Inventors: Yasuo Yamada, Tokyo (JP); Eiji Kogo, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/907,882

(22) Filed: Oct. 18, 2007

(30) Foreign Application Priority Data
Dec. 13, 2006 (JP) 2006-336222

(51) Int. Cl. H04B 1/38; H04M 1/00

(52) U.S. Cl. 455/557

(57) ABSTRACT

According to one embodiment, a personal computer is configured to set automatically a communication rate for AV (audio/video) data outputted to an AV communication device to one of three levels, which are high sound quality, standard sound quality, and low sound quality, according to the number of connections of communication devices detected by a connection number detecting unit. Therefore, skipping of sound in the AV communication device can be prevented without imposing a load of operation to set the sound quality on the user side. Regarding setting of the communication rate, since the number of connections of the communication devices is detected, a processing procedure can be simplified as compared to the case where the communication state is monitored directly as in a conventional manner and then setting of communication rate is changed every time the transmission of AV data is carried out.

### CROSS-REFERENCE TO RELATED APPLICATIONS

This application is based upon and claims the benefit of priority from Japanese Patent Application No. 2006-336222, filed Dec. 13, 2006, the entire contents of which are incorporated herein by reference.

### BACKGROUND

1. Field

One embodiment of the invention relates to a radio communication apparatus, a communication rate setting method, and a communication rate setting program recording medium.

2. Description of the Related Art

In recent years, there are wireless AV systems constituted by connecting a main device such as a personal computer and an AV (audio/video) device such as a headphone or a TV monitor by means of local radio communication, which is represented by Bluetooth™. As such a system, for example, there is a wireless AV system described in Japanese Patent Application Publication (KOKAI) No. 2004-320770. In this conventional wireless AV system, control is performed to change a communication rate for AV data according to a communication state between the main device and the AV device. For controlling the communication rate, a maximum value and a minimum value of the communication rate are set in advance for each type of contents to be transmitted to the AV device side, and thereby it is realized to suppress skipping of an image or sound in a case that the communication state is deteriorated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram showing a configuration of a personal computer that is one embodiment of a radio communication apparatus according to the invention;

FIG. 2 is an exemplary diagram showing a hardware configuration of the personal computer shown in FIG. 1;

FIG. 3 is an exemplary diagram showing a software configuration of the personal computer shown in FIG. 1;

FIG. 4 is an exemplary flowchart showing an operation of the personal computer when starting a connection of an AV communication device;

FIG. 5 is an exemplary flowchart showing an operation of the personal computer to which the AV communication device is connected;

FIG. 6 is an exemplary flowchart showing another operation of the personal computer to which the AV communication device is connected;

FIG. 7 is an exemplary diagram showing one embodiment of a communication rate setting program recording medium according to the invention; and

FIG. 8 is an exemplary perspective view showing a personal computer for executing a communication rate setting program recorded in the recording medium.

### DETAILED DESCRIPTION

Various embodiments according to the invention will be described hereinafter with reference to the accompanying drawings. In general, according to one embodiment of the invention, a radio communication apparatus includes a connection control device for establishing a connection with an AV (audio/video) communication device to be an output destination of AV data and connections with other communication devices by local radio communication, a connection number detecting device for detecting a number of connections of the other communication devices, and a communication rate setting device for setting a communication rate for the AV data outputted to the AV communication device according to the number of connections of the other communication devices detected by the connection number detecting device. Then, the communication rate for AV data outputted to the AV communication device is set automatically according to the number of connections of the AV communication devices detected by the connection number detecting device.

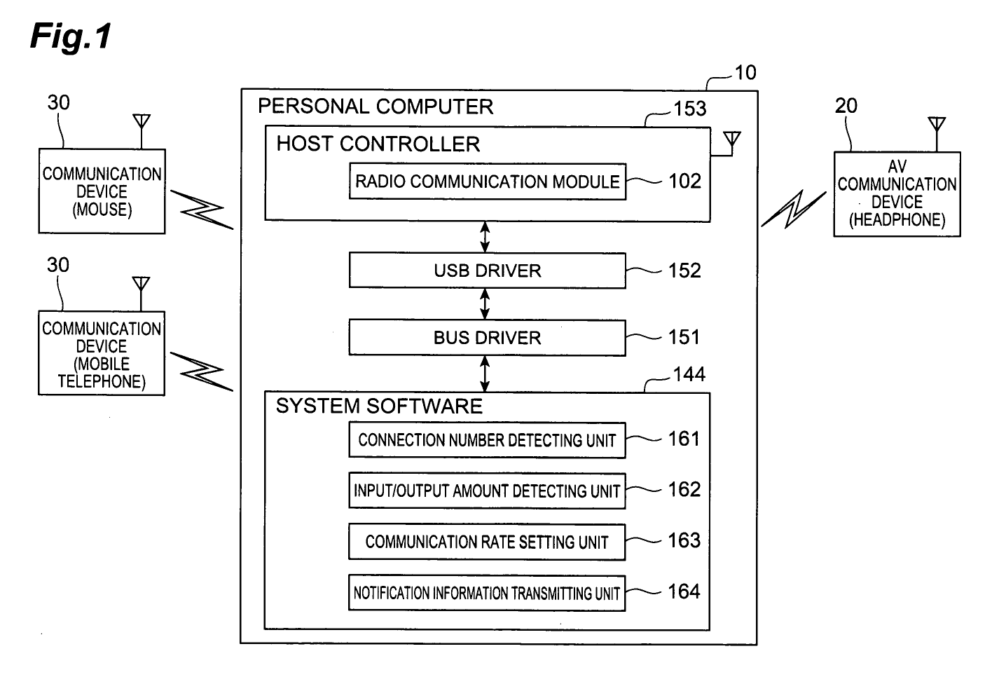

FIG. 1 is a diagram showing a configuration of a personal computer that is one embodiment of a radio communication apparatus according to the invention. The personal computer (radio communication apparatus) 10 shown in FIG. 1 is connectable with an AV communication device 20 and a plurality of communication devices (other communication devices) 30. The AV communication device 20 is a headphone for music for example, and is a device to be an output destination of AV data (audio/video data) from the personal computer 10. Further, each of the communication devices 30 is a mouse or a mobile phone for example, and is a device capable of transmitting/receiving various types of data other than AV data to/from the personal computer 10.

The personal computer 10 and the AV communication device 20 as well as the personal computer 10 and the communication devices 30 are connected by radio communication such as Bluetooth for example in a manner to be capable of performing data communication. The Bluetooth is one of local radio communication standards, which realizes radio communication within approximately 10 meters using a radio wave of 2.45 GHz band. Thereby, besides having regular functions such as a Web browsing function and/or a word processor function, the personal computer 10 functions as an AV system for allowing a user to listen to music or view a video in a wireless manner.

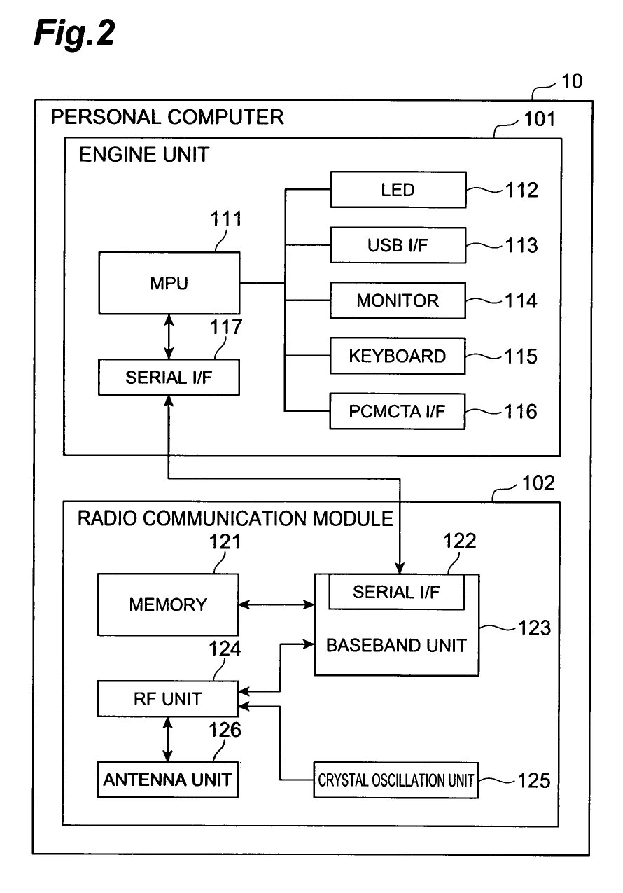

FIG. 2 shows a hardware configuration of the personal computer 10. As shown in this diagram, the personal computer 10 includes an engine unit 101 that is a main unit of the personal computer 10, and a radio communication module (connection control unit) 102 for controlling radio communication by means of Bluetooth. The engine unit 101 is constituted including an MPU 111, which is constituted including a CPU, a memory, and a peripheral control circuit, an LED 112 for indicating warning or the like, a USB interface 113, a monitor 114 as an output device, a keyboard 115 as an input device, a PCMCIA (Personal Computer Memory Card International Association) interface 116 for mounting a PC card, and a serial interface 117.

On the other hand, the radio communication module 102 is constituted of a memory 121, a serial interface 122, a base band unit 123, an RF (Radio Frequency) unit 124, a crystal oscillation unit 125, and an antenna unit 126. The serial interface 122 connects the radio communication module 102 and the engine unit 101 by cooperating with the serial interface 117 on the engine unit 101 side.

The base band unit 123 performs protocol processing for converting data to be transmitted to the AV communication device 20 or the communication devices 30 into a digital signal that can be handled by the RF unit 124. The RF unit 124 mix the digital signal that is converted and processed in the base band unit 123 with a frequency signal oscillated from the crystal oscillation unit 125, and demodulates the mixed signal to a radio wave having a 2.45 GHz band. The antenna unit 126 transmits/receives a radio wave to/from the AV communication device 20 and the communication devices 30.

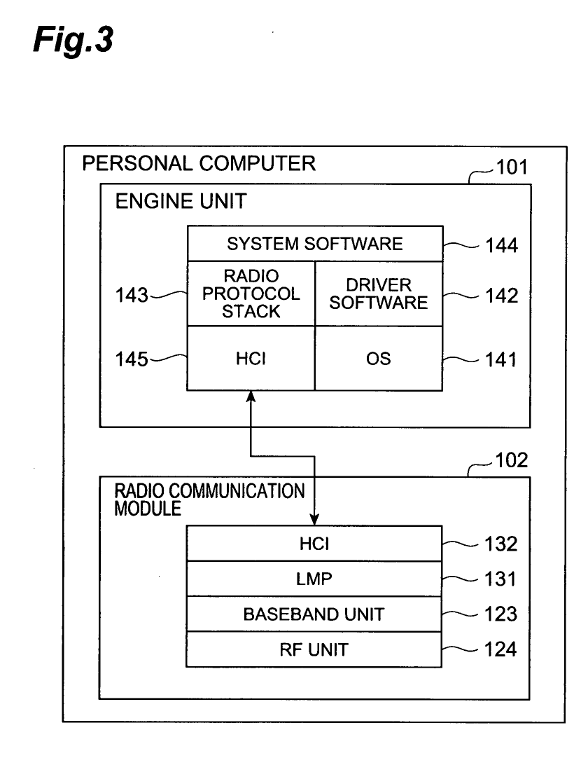

FIG. 3 is a diagram showing a software configuration of the personal computer 10. As shown in this diagram, in the personal computer 10, an LMP (Link Management Protocol) 131 and an HCI (Host Control Interface) 132 are mounted in the base band unit 123 of the radio communication module 102. The LMP 131 controls a radio link with the radio communication module on the AV communication device 20 or the communication devices 30 side. Further, the HCI 132 performs serial interface processing with the engine unit 101.

Further, in the engine unit 101, there are mounted an operating system 141, driver software 142, a radio protocol stack 143, a system software 144, and an HCI 145. The operating system 141 controls basic functions used in common by a large number of application software, including an input/output function such as keyboard input or screen output, management of memory, and so forth. The driver software 142 controls various types of peripheral devices. The radio protocol stack 143 controls radio communication in the 2.45 GHz band. The system software 145 realizes a communication rate setting function for AV data, which will be described later. The HCI performs serial interface processing with the HCI 132 on the radio communication module 102 side.

In a memory of such a personal computer 10, as shown in FIG. 1, a BUS driver 151, a USB driver 152, and system software 144 are resident. The BUS driver 151 controls a host controller 153 for Bluetooth via the USB driver 152. The system software 144 has, as functional components for performing a communication rate setting function for AV data, a connection number detecting unit (connection number detecting device) 161, an input/output amount detecting unit (input/output amount detecting device) 162, a communication rate setting unit (communication rate setting device) 163, and a notification information transmitting unit (notification information transmitting device) 164.

The connection number detecting unit 161 is a part for detecting the number of connections of the communication devices 30. More specifically, the connection number detecting unit 161 detects the number of connections of the communication devices 30 currently connected to the personal computer 10 when a connection by means of Bluetooth is newly started between the AV communication device 20 and the personal computer 10.

Further, in a case that a connection by means of Bluetooth is established between the AV communication device 20 and the personal computer 10, the connection number detecting unit 161 detects the number of connections of the communication devices 30 currently connected to the personal computer 10 when a connection by means of Bluetooth with one of the communication devices 30 is established or cut off. The connection number detecting unit 161 generates detection result information indicating a detection result of the number of connections, and outputs the detection result information to the communication rate setting unit 163.

The input/output amount detecting unit 162 is a part for detecting a data input/output amount to/from the communication devices 30. In a case that a connection by means of Bluetooth is established between the AV communication device 20 and the personal computer 10, the input/output amount detecting unit 162 detects a data input/output amount exchanged between the personal computer 10 and the respective communication devices 30. The input/output amount detecting unit 162 generates detection result information indicating the detected data input/output amount, and outputs the detection result information to the communication rate setting unit 163.

The communication rate setting unit 163 is a part for setting a communication rate for AV data outputted to the AV communication device 20. The communication rate setting unit 163 sets the communication rate for AV data in three levels based on detection result information received from the connection number detecting unit 161.

More specifically, the level of the communication rate is set to “high sound quality” (400 kbps for example) when the number of connections of the communication devices 30 indicated by the detection result information is 0 (zero), and the level of the communication rate is set to “standard sound quality” (200 kbps for example) when the number of connections of the communication devices 30 is 1. Further, the level of the communication rate is set to “low sound quality” (100 kbps for example) when the number of connections of the communication devices 30 is 2 or more.

Further, the communication rate setting unit 163 performs similar communication rate setting based on detection result information received from the input/output amount detecting unit 162. In the communication rate setting unit 163, an allowable range of a data input/output amount is set for each level of the communication rate. For example, the range of the data input/output amount is 0 (zero) kbps to 100 kbps in the case of the “high sound quality”, and the range of the data input/output amount is 50 kbps to 300 kbps in the case of the “standard sound quality”. Further, the range of the data input/output amount is 150 kbps to 400 kbps in the case of the “low sound quality”.

Then, the communication rate setting unit 163 changes the setting of the level of the communication rate for AV data to one level lower in a case that the data input/output amount exceeds the upper limit of an allowable range of the data input/output amount for the current communication rate, and changes setting of the level of the communication rate for AV data to one level higher in a case that the data input/output amount is less than the lower limit of the allowable range of the data input/output amount for the current communication rate. Further, the communication rate setting unit 163 outputs instruction information of instructing generation of notification information to the notification information transmitting unit 164 in a case that the data input/output amount exceeds the upper limit of an allowable range of the data input/output amount for the “low sound quality”.

The notification information transmitting unit 164 is a part for transmitting, when the communication rate for AV data decreases to be equal to or lower than predetermined setting, notification information indicating the decrease to the AV communication device 20. The notification information transmitting unit 164 generates the notification information when it receives instruction information from the communication rate setting unit 163, and transmits the notification information to the AV communication device 20 via the radio communication module 102. Note that as the notification information described here, there are warning sound or waning message information for example. Further, it may be information instructing to vibrate in a case that the AV communication device 20 has a vibration function. Further, it may be configured on the personal computer 10 side to display the notification information by lighting the LED 112 or displaying a warning message on the monitor 114.

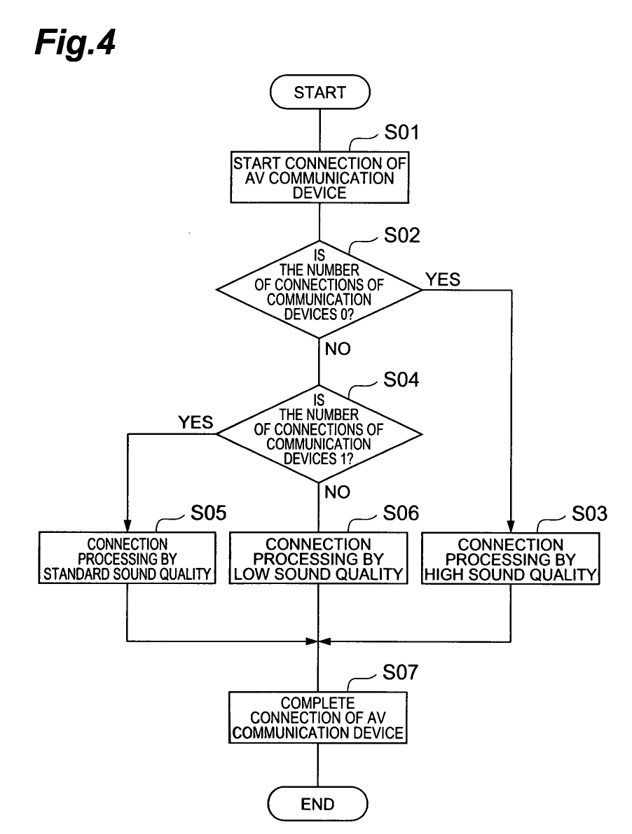

Next, the operation of the personal computer 10 having the above configuration will be described with reference to flowcharts shown in FIG. 4 to FIG. 6.

As shown in FIG. 4, when a connection between the AV communication device 20 and the personal computer 10 by means of Bluetooth is newly started, the number of connections of the communication devices 30 which are currently connected to the personal computer 10 is detected (block S01). Here, whether the number of connections of the communication devices 30 is 0 (zero) or not is determined first (block S02). When the number of connections is 0, the level of the communication rate for AV data is set to the “high sound quality”, and then connection processing is performed (block S03).

Further, when the number of connections of the communication devices 30 is not 0 in block S02, whether the number of connections is 1 or not is determined next (block S04). When the number of connections of the communication devices 30 is 1, the level of the communication rate for the AV data is set to the “standard sound quality”, and then connection processing is performed (block S05). Further, when the number of connections is 2 or more, the level of the communication rate for AV data is set to the “low sound quality”, and then connection processing is performed (block S06). After blocks S03, S05, S06, the processing is finished when the connection to the AV communication device 20 is completed (block S07).

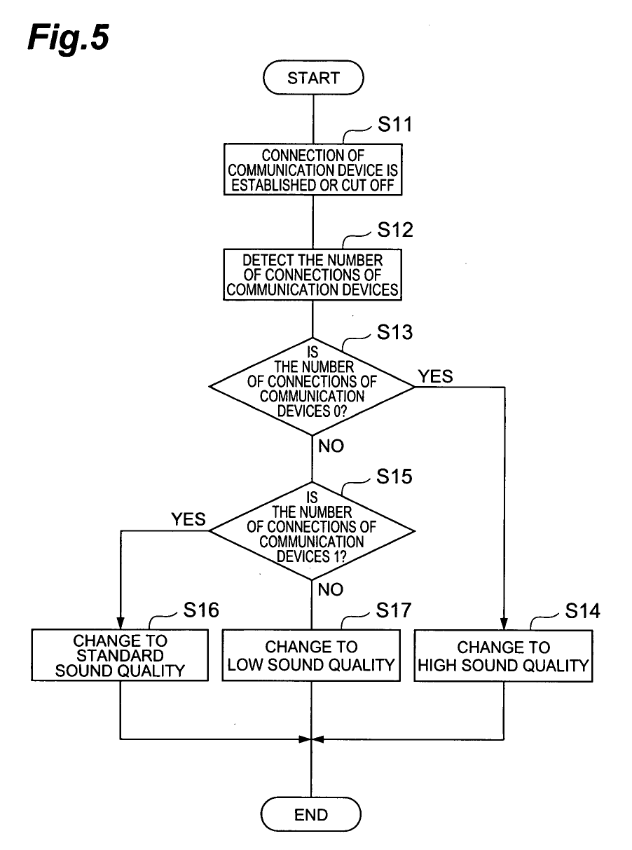

As shown in FIG. 5, in a case that a connection by means of Bluetooth is established between the AV communication device 20 and the personal computer 10, the number of connections of the communication devices 30 currently connected to the personal computer 10 is detected again (block S12) when a connection of one of the communication devices 30 is established or cut off (block S11). First, whether the number of connections of the communication devices 30 is 0 (zero) or not is determined (block S13). When the number of connections is 0, setting of the level of the communication rate for AV data is changed to the “high sound quality” (block S14).

In block S13, when the number of connections of the communication devices 30 is not 0, whether the number of connections is 1 or not is determined next (block S15). When the number of connections of the communication devices 30 is 1, setting of the level of the communication rate for AV data is changed to the “standard sound quality” (block S16). Further, when the number of connections is two or more, setting of the level of the communication rate for AV data is changed to the “low sound quality” (block S17).

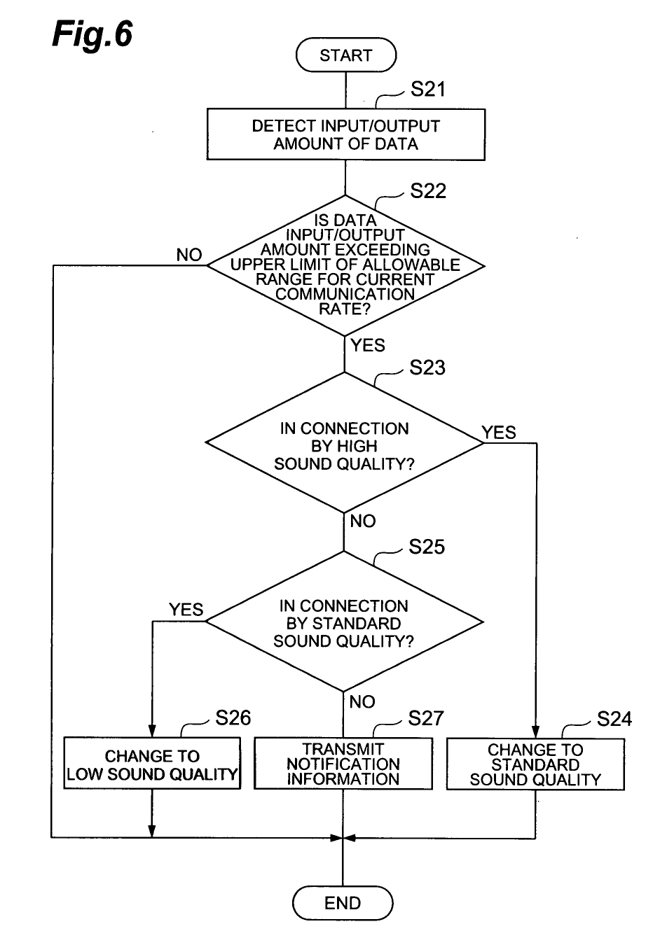

Further, as shown in FIG. 6, in a case that a connection by means of Bluetooth is established between the AV communication device 20 and the personal computer 10, the data input/output amount exchanged at predetermined cycles between the personal computer 10 and each of the communication devices 30 is detected (block S21). Then, it is determined whether or not the detected data input/output amount exceeds the upper limit of the allowable range for the current communication rate (block S22).

In block S22, when the detected data input/output amount does not exceed the upper limit of the allowable range for the current communication rate, the processing is finished without changing the setting of the communication rate for AV data. On the other hand, when the detected data input/output amount exceeds the upper limit of the allowable range for the current communication rate, it is determined next whether the level of the currently set communication rate is the “high sound quality” or not (block S23). When the level of the currently set communication rate is the “high sound quality”, setting of the level of the communication rate is changed to the “standard sound quality”, which is one level lower (block S24).

When the level of the currently set communication rate is not the “high sound quality”, it is determined whether the level of the currently set communication rate is “standard sound quality” or not (block S25). When the level of the currently set communication rate is the “standard sound quality”, setting of the level of the communication rate is changed to the “low sound quality”, which is one level lower (block S26). Further, when the level of the currently set communication rate is not the “standard sound quality”, in other words, when the level of the currently set communication rate is already the “low sound quality”, notification information is transmitted to the AV communication device 20 (block S27).

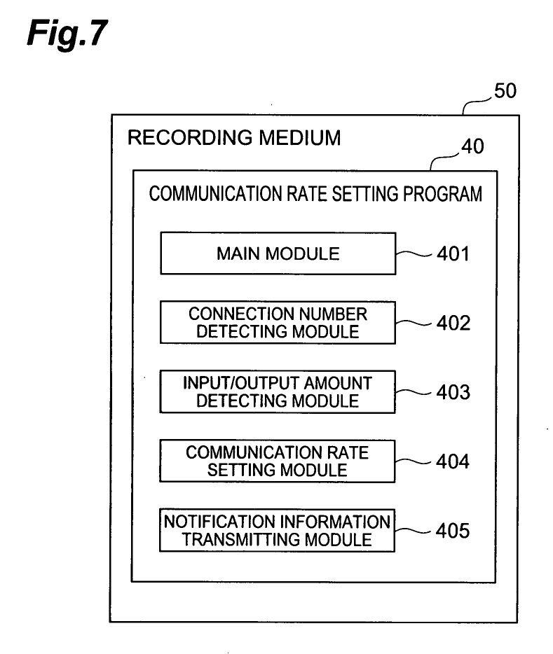

Next, a communication rate setting program recording medium for enabling a personal computer to have the above-described communication rate setting function will be described. FIG. 7 is a diagram showing a configuration of the communication rate setting program recording medium.

As shown in FIG. 7, the communication rate setting program recording medium 50 records a communication rate setting program 40. The communication rate setting program 40 includes a main module 401 which controls overall processing, a connection number detecting module 402, an input/output detecting module 403, a communication rate setting module 404, and a notification information transmitting module 405.

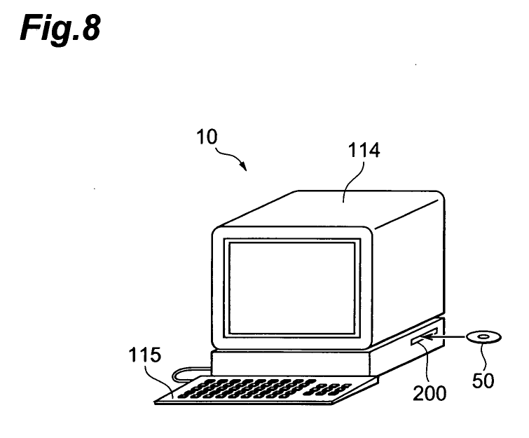

Functions realized by executing the above respective modules are the same as those of the respective functional components of the above-described personal computer 10. In other words, functions of the respective modules of the communication rate setting program 40 are identical to the functions of the connection number detecting unit 161, the input/output amount detecting unit 162, the communication rate setting unit 163, and the notification information transmitting unit 164. As shown in FIG. 8, when the recording medium 50 is inserted into a reading device 200, the personal computer 10 becomes capable of accessing the communication rate setting program via the reading device 200, and becomes capable of operating as an apparatus having the communication rate setting function according to this embodiment.

As described above, the personal computer 10 is configured to set automatically the level of the communication rate for AV data outputted to the AV communication device 20 to one of the three levels, which are the high sound quality, the standard sound quality, and the low sound quality, according to the number of connections of the communication devices 30 detected by the connection number detecting unit 161. Therefore, skipping of sound in the AV communication device 20 can be prevented without imposing a load of operation to set the sound quality on the user side. Regarding setting of the communication rate, since the number of connections of the communication devices 30 is detected, a processing procedure can be simplified as compared to the case where the communication state is monitored directly as in a conventional manner and then setting of communication rate is changed every time the transmission of AV data is carried out.

Further, in the personal computer 10, setting of the communication rate for AV data to be outputted to the AV communication device 20 is changed according to the data input/output amount detected by the input/output amount detecting unit 162, in addition to setting of the communication rate according to the number of connections of the communication devices. Accordingly, the function to prevent skipping of sound in the AV communication device 20 can be further enhanced. Further, in this change of setting, setting of the level of the communication rate for AV data is changed in levels in the case where the data input/output amount deviates from an allowable range of the data input/output amount for the current communication rate. Therefore, it is possible to prevent a rapid change of the communication rate, and prevent giving the user unpleasant feeling.

Further, in the personal computer 10, when the data input/output amount to/from the communication devices 30 exceeds the upper limit of an allowable range in the case of the communication rate “low sound quality”, notification information indicating this exceeding is transmitted to the AV communication device 20. Accordingly, decrease of the communication rate can be notified to the user side quickly, thereby constructing a user friendly AV system.

The invention is not limited to the above-described embodiments. For example, in the above-described embodiments, the headphone for music is presented as an example of the AV communication device 20, but it may be a device outputting a video, such as a TV monitor. Further, a device to detect an error rate of AV data outputted to the AV communication device 20 may be included further, by which notification information is transmitted to the AV communication device 20 when the error rate exceeds a predetermined threshold value.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communication apparatus, comprising:
a connection control device for establishing a connection with an AV (audio/video) communication device to be an output destination of AV data and connections with other communication devices by local radio communication;
a connection number detecting device for detecting a number of connections of the other communication devices; and
a communication rate setting device for setting a communication rate for the AV data outputted to the AV communication device according to the number of connections of the other communication devices detected by said connection number detecting device.

2. The radio communication apparatus according to claim 1, wherein
said communication rate setting device turns the communication rate for the AV data to a low level according to increase of the number of connections of the other communication devices, and turns the communication rate for the AV data to a high level according to decrease of the number of connections of the other communication devices.

3. The radio communication apparatus according to claim 1, wherein
said connection number detecting device detects the number of connections of the other communication devices when a connection by the local radio communication with one of the other communication devices is established or cut off in a case that the connection with the AV communication device by the local radio communication is established.

4. The radio communication apparatus according to claim 1, wherein:
said connection number detecting device detects the number of connections with the other communication devices when a connection with the AV communication device by the local radio communication is started; and
said connection control device establishes a connection with the AV communication device at a communication rate set by said communication rate setting device according to the number of connections.

5. The radio communication apparatus according to claim 1, further comprising
an input/output amount detecting device for detecting a data input/output amount to/from the other communication devices in a case that a connection with the AV communication device by the local radio communication is established, wherein
said communication rate setting device sets the communication rate for the AV data to be outputted to the AV communication device according to the data input/output amount detected by said input/output amount detecting device.

6. The radio communication apparatus according to claim 1, further comprising
a notification information transmitting device for transmitting, when the communication rate for the AV data decreases equal to or lower than predetermined setting, notification information indicating the decrease to the AV communication device.

7. A communication rate setting method for AV data in a radio communication apparatus comprising a connection control device for establishing a connection with an AV (audio/video) communication device to be an output destination of AV data and connections with other communication devices by local radio communication, the method comprising:
a connection number detecting step of detecting by a connection number detecting device a number of connections of the other communication devices; and
a communication rate setting step of setting by a communication rate setting device a communication rate for the AV data outputted to the AV communication device according to the number of connections of the other communication devices detected by the connection number detecting device.

8. A computer readable communication rate setting program recording medium for use in a radio communication apparatus which comprises a connection control device for establishing a connection with an AV (audio/video) communication device to be an output destination of AV data and connections with other communication devices by local radio communication, the recording medium comprising a communication rate setting program recorded therein for enabling the radio communication apparatus to function as:
a connection number detecting device for detecting a number of connections of the other communication devices; and
a communication rate setting device for setting a communication rate for the AV data outputted to the AV communication device according to the number of connections of the other communication devices detected by the connection number detecting device.
